(19) United States
(12) Patent Application Publication
(10) Pub. No.: US 2007/0240755 A1
(43) Pub. Date: Oct. 18, 2007

(54) Apparatus and method for construction and placement of a non-equatorial photovoltaic module

(75) Inventor: Joseph I. Lichy, San Jose, CA (US)

Correspondence Address: MARK A. THOMAS, P.C., 10138 SOUTH COTTONCREEK DRIVE, HIGHLANDS RANCH, CO, 80130-3848, US

(73) Assignee: NuEdison Corporation, San Jose, CA (US)

(21) Appl. No.: 11/725,665

(22) Filed: Mar. 20, 2007

Related U.S. Application Data
(60) Provisional application No. 60/784,714, filed on Mar. 22, 2006.
(60) Provisional application No. 60/864,920, filed on Nov. 8, 2006.

(51) Int. Cl. H02N 6/00

(52) U.S. Cl. 136/246

(57) ABSTRACT

An apparatus and method is disclosed which employs a light concentrator with an asymmetric acceptance angle to concentrate sunlight on predominately non-equatorial facing surfaces such as roof tops. In some embodiments a photovoltaic module is disclosed using triangular prisms to concentrate light onto silicon cells, thereby reducing the amount of photovoltaic material required for generation of electrical power from sunlight without reducing the amount of light accepted by the module on non-equatorial surfaces in the northern and southern hemispheres. In some other embodiments parallel aperture concentrators are used in place of triangular prisms.

### CROSS-REFERENCE TO RELATED APPLICATION(S)

This application claims the benefit of U.S. Provisional Patent Application No. 60/784,714, filed Mar. 22, 2006 and U.S. Provisional Patent Application No. 60/864,920, filed Nov. 8, 2006.

### FIELD OF INVENTION

The present invention relates to an apparatus and method of use of an improved photovoltaic module, more specifically, a light concentrating photovoltaic module for use in predominantly non-equatorial facing orientations.

### BACKGROUND

Photovoltaic (PV) modules convert sunlight into electricity. In their most common use they are mounted on the most predominantly equatorial facing roofs available on buildings to generate electrical power for use within those buildings. Recently, as a result of technological progress and government subsidies, PV modules have begun to be installed widely on roofs and other surfaces generally oriented to face the sun for most of the year. For example, PV modules in California are typically placed on the most southerly facing roof surfaces. Unfortunately, many structures do not have sufficient sun-facing, or equatorial-facing roof space oriented in this manner to install an appropriately sized PV system.

One way to increase the cost effectiveness of using PV modules is to use a light concentrator to boost the intensity of the light reaching the PV cell in the PV module. Concentrating PV modules reduce the amount of photovoltaic material required in a photovoltaic (PV) system, thereby reducing system cost. While properly designed and installed concentrating PV modules improve the economics of a given PV system, they are still limited to the amount of usable equatorial facing building surfaces, which is often insufficient for the occupants of that building.

It would be desirable to at least partially address some or all of the concerns referred to herein.

### SUMMARY

Some of the limitations of currently existing PV module installations are mitigated or overcome in accordance with preferred embodiments of the present invention as described below. Some embodiments of the present invention employ a concentrator with a PV module to concentrate sunlight on predominately non-equatorial facing building surfaces such as roof tops and walls.

### DRAWINGS

Drawing Figures

FIG. 1 is a view of a building with both equatorial and non-equatorial facing roof space, were the equatorial facing roof is shadowed

FIG. 2 is a perspective view of a triangular prism concentrator array;

FIG. 3 is a perspective view of the optical element of a triangular prism concentrator array;

FIG. 4 is a detailed perspective view of the triangular prism concentrator array;

FIGS. 5A-5D are ray diagrams showing ray traces in the triangular prism concentrator array;

FIG. 6 is a side view of a parallel aperture prismatic light concentrator;

FIG. 7 is a perspective view of the coplanar prismatic light concentrator in a photovoltaic module;

FIG. 8 is a schematic side view showing the physical interpretation of various acceptance angles;

FIG. 9 is a graph showing the concentration factor of the triangular prism concentrator for a given acceptance angle as compared to an ideal value;

FIG. 10 is a graph showing PV module performance vs. concentration for a module aligned to the equatorial plane;

FIG. 11 is a graph showing PV module performance vs. concentration of a PV module mounted flat on a flat roof in San Jose, Calif.;

FIG. 12 is a graph showing PV module performance for a non-equatorial facing, in this case, a north facing roof setting in the northern temperate zone;

FIG. 13 is a schematic view of the application of the TPC PV module in a non-equatorial orientation;

FIGS. 14A-D are ray traces through a TPC optimized for placement in a non-equatorial orientation; and

FIG. 15 is a schematic view of the application of the TPC PV module in another non-equatorial orientation, where the normal is outside the ecliptic on the horizon side (further south in the northern hemisphere, further north in the southern hemisphere), and the PV module is part of a vertical wall; and

### DETAILED DESCRIPTION

Embodiments of a photovoltaic (PV) concentrator module adapted for non-equatorial orientations are described in detail herein. The concentrator can take numerous forms such as a triangular prism concentrator, a parallel aperture prismatic light concentrator or other asymmetric concentrators. The term “non-equatorial” is defined herein such that a PV concentrator module positioned in a non-equatorial orientation can never face the sun squarely at any time of the year because it is tilted away from the ecliptic, i.e., the plane that the Earth travels around the sun. More specifically, the normal axis, which is perpendicular to the primary plane of the PV concentrator module, is positioned so that it is impossible for the sun to shine directly at the normal axis at anytime of the year, even at the sun's maximum apparent height during the summer solstice. By way of an example, assuming the Earth is tilted 23.45 degrees with respect to the ecliptic, a PV concentrator module mounted flat on a roof surface at 33.45 degrees north latitude that is tilted less than 10 degrees south is in a non-equatorial orientation. If the tilt of the PV concentrator module were increased to 10 degrees south or somewhat more, as long as the sun can shine directly on the normal axis, then it would be considered to be equatorially aligned and outside the scope of this invention. By way of another example, a concentrating PV module placed on a locally flat horizontal surface outside of the tropics (greater than approximately 23.45 degrees latitude from the equator) is non-equatorial because the sun cannot shine directly down onto the normal axis of the concentrating PV module. In the Northern Hemisphere, many non-equatorial facing surfaces often, but not necessarily face predominately northward, correspondingly, in the Southern Hemisphere, non-equatorial facing surface often but not necessarily face predominately southward. However, a southerly facing surface in the Northern Hemisphere or a northerly facing surface in the Southern Hemisphere may be considered non-equatorial facing. One example of this case would be that a southerly facing surface at 45 degrees latitude that is tilted up only 15 degrees is non-equatorial facing. By way of another example, non-equatorial facing surfaces can point more predominantly to either of Earth's rotational poles outside of the ecliptic. In many situations a vertical wall is at a latitude such that the normal axis perpendicular to the plane of the wall will never be aligned directly with the sun. For example, a vertical wall facing due south in California has a normal axis that never is directly aligned with the incoming rays of the sun.

Embodiments of the present invention include a PV concentrator module for the distributed generation (“DG”) market. Some embodiments include a concentration factor up to 7.5 in conjunction with the use of triangle prism concentrators (TPC), which yields practical modules with significant advantages over one-sun modules and few of the drawbacks of higher concentration modules in equatorial facing orientations. In some embodiments we show that higher concentration factors are possible with triangle prism concentrators (TPC), or other concentrators with asymmetric acceptance angles for modules in non-equatorial facing orientations.

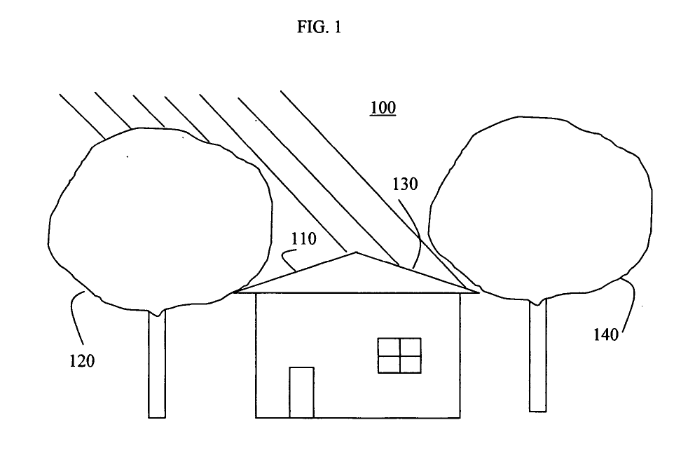

Turning to FIG. 1, there is shown a schematic diagram 100 of a typical building setting having some building surfaces with different orientations with respect towards the sun. In this example, from the perspective of looking due west at a latitude of 35 degrees north, the building contains a shaded equatorial-facing roof 110 sloped at 15 degrees with respect to the Earth. The shaded equatorial-facing roof 110 is shaded in this case by a first large obstruction (tree) 120, which is typical in suburban settings. Note, however, the large obstruction 120 could be anything opaque to sunlight, including another structure. Adjacent to the shaded equatorial-facing roof 110 is an unshaded non-equatorial roof 130. Like the shaded equatorial-facing roof 110, the unshaded non-equatorial roof 130 is also sloped 15 degrees with respect to the surface of the Earth as shown, but in the opposite direction. As can be clearly seen in this example, the equatorial roof 110 is shaded by the tree 120, but the non-equatorial roof 130 is not shaded by the tree 120. Furthermore, a second large obstruction (tree) 140, similar to the first large obstruction 120, does not cast a shadow onto the non-equatorial roof 120 because of the apparent path of the sun through the sky. For this reason, embodiments of the present invention are able to take advantage of a heretofore unappreciated feature of non-equatorial facing surfaces 130, and that is they are less likely to be shaded than equatorial facing surfaces. This is a significant advantage to increasing the electricity generating capacity of building surfaces.

An important difficulty for distributed PV is area efficiency. Whereas a remote generating station may be located in an area with abundant cheap real estate, distributed systems should be placed more near the load—typically on the roof of a building. Taking a residential example, a typical Californian consumes about 568 kWhr/month (substantially less than the national average) according to California Energy Commission data for 2001 available at www.energy.ca.gov/electricity/us_percapita_electricity.html. Meeting this load with a typical silicon based PV system requires 320 sq. ft. of equatorial oriented roof space. With typical development densities of 20 units per acre available roof area is limited to 540 sq. ft. Roof features such as hips, chimneys and gables can easily reduce this by half. While commercial buildings may have less constrained roof areas, electrical power consumption in these buildings is generally higher so area efficiency remains an important consideration. Accordingly, it is desirable to open up currently unused or uneconomical parts of the total building exterior, especially non-equatorial parts, to include a PV system for collecting solar energy. Prior art PV concentrators require alignment, at least generally towards the equatorial plane, and often must be pointed directly at the sun to function properly. The present invention uses the advantageous properties of an asymmetric concentrator (one in which the acceptance angle is not centered around the surface normal) to allow placement with non-equatorial alignment. Some embodiments of the present invention are adapted primarily for non-equatorial alignment, thus enabling higher concentration factors and greater cost savings in conjunction with greater roof space utilization. Some embodiments employ a triangular prism concentrator array contained within a relatively flat surfaced module that can be mounted flush to a non-equatorial facing roof surface. Embodiments of the PV concentrator module described herein are more economical because they open up new roof space to efficient PV electricity generation and require little or no maintenance because they are stationary. In addition, because placement of the PV panels is no longer restricted to equatorially facing roofs, the present invention may provide a more aesthetic solution by giving the installer the option of installing the system on the rear of a building. Furthermore, north facing roofs are less likely to be shadowed by foliage in close proximity to the building. This is because the north facing roof is necessarily set back from any foliage on the south side of the house. This is illustrated in FIG. 1.

Area Efficiency—Diffuse Light Acceptance

Area efficiency is a measure of how much power can be generated from a given area of PV system. Area efficiency is impacted by diffuse light acceptance. A light concentrator can only receive light from a limited range of incident angles, and therefore only a limited portion of the sky. Most prior art light concentrators accept light from a range of angles centered on the surface normal. The maximum angle that incident light can make with the surface normal and still be absorbed, or accepted, by the light concentrator is known as the “acceptance angle.” The acceptance angle for an ideal concentrator is directly related to the concentration factor, and is given by the equation:
θₐ=arc Sin(n/CF) (1)

From Winston, Roland, Light Collection within the Framework of Geometrical Optics, Journal of the Optical Society of America, Vol. 60(2), pp. 245-247 (February 1970).

Where θₐ is the acceptance half angle, n is the index of refraction at the target PV cell, and CF is the geometric concentration factor. In order to collect all diffuse light a concentrator requires θₐ=90° which implies:
arc Sin(n/CF)=90° (2)
CF=n (3)

In this case, the light must be contained in a medium with a refractive index greater than 1 in order to achieve concentration greater than 1. It is not necessary that 100% of diffuse light is collected. Higher concentrations may be appropriate if sufficient economic gain can be demonstrated as will be explained below, but it is a good starting point for a DG concentrator.

We can put an upper end of a preferred range on the concentration factor using the well known analysis of Ari Rabl showing that a stationary concentrator should have a minimum acceptance half angle of about 30°. The analysis of Ari Rabl can be found in, for example, in Rabl, Ari, Comparison of Solar Concentrators, Solar Energy, Vol. 18, pp. 93-111 (1976). This yields a maximum CF of 3. We have therefore placed the first quantitative bounds on the DG concentrator design:
CF<3 (5)

Another way of looking at this is that light concentration is essentially a process of reducing the spatial distribution of light by increasing the angular distribution. This process was quantified by Roland Winston, in Light Collection within the Framework of Geometrical Optics, Journal of the Optical Society of America, Vol. 60(2), pp. 245-247 (February 1970) and can be expressed as:
nᵢXᵢ Sin(θᵢ)=nₗXₗ Sin(θₗ) (6)

Where nᵢ is the refractive index at a distance i in the concentrator, Xᵢ is the spatial distribution of the light at i (the width of the collector at i), and θᵢ is the angular distribution (maximum angle of collected light propagating through i).

It should be noted that this upper bound is based on the assumption that the concentrator's acceptance angle is symmetric about the surface normal. Some embodiments of the present invention employ asymmetric concentrators, where the phase space equation (equation 1) is modified yielding a different result for equation 5, and allowing for greater concentration factors. Rabl's result—that a stationary concentrator must accept light from a 60° sweep of sky remains valid, however.

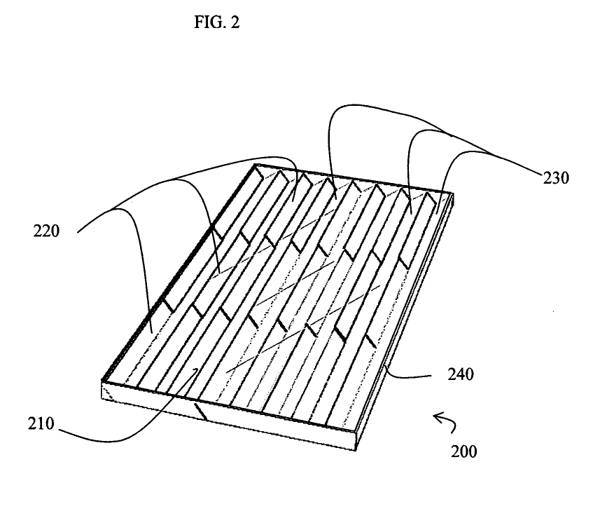

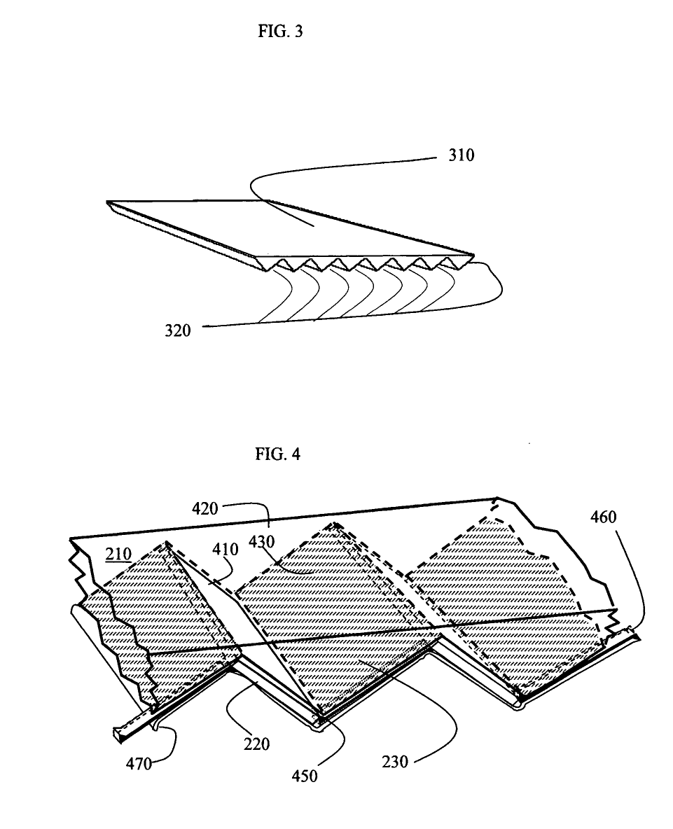

One example of a photovoltaic module utilizing an asymmetric concentrator is illustrated in FIG. 2. FIG. 2 shows a triangular prism concentrator (TPC) array photovoltaic module 200. The triangle prism concentrator is described in the literature, for example, in Japanese Kokai Patent Application No. SHO 54-18762, 1979, “Focusing and Dispersing Device of Radiation” by David Roy Mills. A brief description of the physical relationships between various components of the module 200 is included here to aid in the understanding of the present invention. The description also references FIGS. 3 and 4 which break out and enlarge components of module 200 illustrated in FIG. 2. The module 200 is made up of a front glass 210 with a flat front surface 310 and a back surface formed to create multiple triangular prisms 320. The flat front surface 310 acts as a second side of each triangular prism 420, as is described in detail below. Photovoltaic cells 220 are arrayed along a first side 410 of each of the prisms of the front glass 210. A second side 420 of each of the triangular prisms 320 is formed by the flat front surface 310 of the front glass 210. A reflective surface (Reflectors) 230 is added to a third side 430 of each triangular prism 320. The reflectors 230 may be formed by coating the third side 430 of each triangular prism 320 with a reflective material, or a separate mirror may be used. A rigid frame 240 surrounds the module providing mechanical stiffness and offering a surface for bolting to rails mounted on a roof.

In some preferred embodiments, the front glass 210 is a molded or extruded clear material having an index of refraction greater than one and preferably between 1.48 and 1.7.

The PV cells 220 are electrically connected to each other by electrical interconnection means 460. In some embodiments electrical interconnect means can be a flat copper wire or tape coated with solder. In some embodiments of the present invention PV cells 220 have one electrical connection on the front side of the cell, and another on the back. In other preferred embodiments the PV cells 220 have two electrical connections on their back surface (facing away from front glass 210), while in other embodiments PV cells 220 have two electrical connections on their front surface (facing towards the front glass 210).

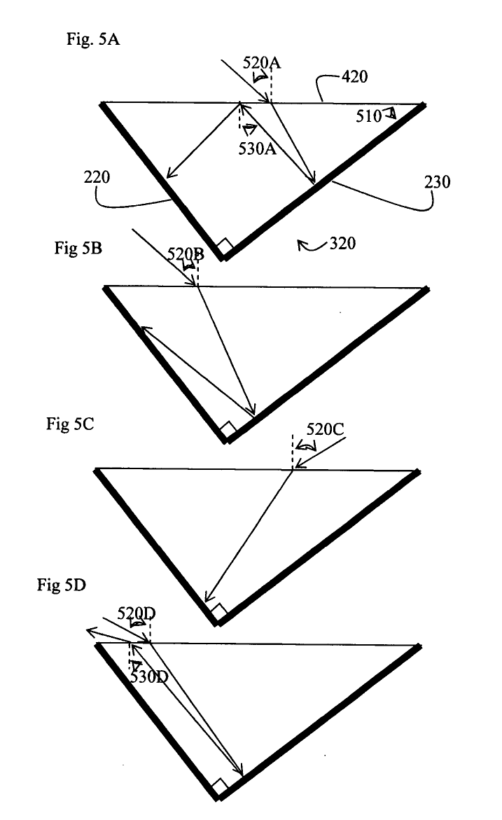

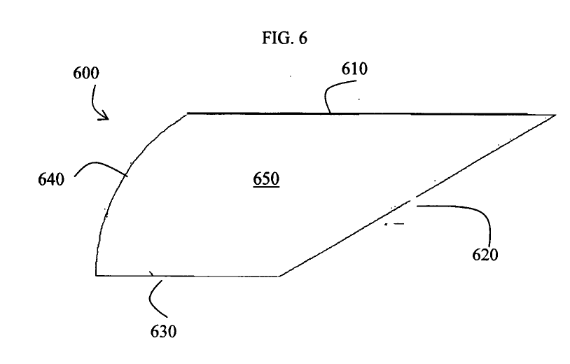

FIGS. 5A-5D show a simplified cross-sectional view of one triangular prism 320 with exemplary light ray traces to illustrate the function of this component. The second surface 420 and the reflector 230 is 380. The other angles are 90° and 520, respectively. The PV cell 220 is disposed at a right angle to the reflector. In FIG. 5A a light ray is incident on prism second surface 420 at incident angle θᵢ 520 of 45°. It is refracted at surface 420 because the index of refraction of the triangular prism 320. The ray then is reflected off reflector 230 and transits the prism 320 a second time, intersecting surface 420 at angle θₗ 530A of 48°. Angle 530A is greater than the critical angle θ_{c} of 41.8° required for total internal reflection, so the ray reflects off surface 420, transits the prism a third time, and impinges on PV cell 220 in order to be converted into electricity.

In FIG. 5B, the light ray is again incident on surface 420 at angle θᵢ 520B of 45°. It is refracted at that surface and transits prism 320 to reflect off reflector 230. In this case, the reflected ray impinges directly on PV cell 220 without any further reflections or refractions.

In FIG. 5C, the ray is incident on surface 420 at angle θᵢ 520C of 70° from the right. After refraction it is directed directly to PV cell 220.

In FIG. 5D, the light ray is incident on surface 420 at angle θᵢ 520D of 70° from the left. After refraction it transits prism 320, reflects off surface 230, transits prism 320 a second time and is incident on surface 420 with incident angle θₗ 530D of 37°. Angle 530D is less than the critical angle for total internal reflection θc of 41.8°, so the light ray is refracted and escapes the concentrator. We say this light is rejected by the concentrator. The rays of FIGS. 5A-5C were all accepted, meaning that they reached the PV cell 120 for potential conversion into electricity.

From the examples of FIGS. 5A-5D, it can be seen that essentially all light incident from the right side is accepted by the triangular prism concentrator. Light incident from the left, however, may be accepted or rejected depending on the magnitude of the incident angle θᵢ. If reflections off the front surface 420 are neglected, then there is some angle θₐ between 520A and 520D for which all light incident with θᵢ<θₐ is accepted, and all light incident with θᵢ>θₐ is rejected. We call this angle θₐ the acceptance angle. The acceptance angle can be computed based on the prism angle φ 510 and the index of refraction of the prism n of each prism 320. The condition for acceptance is that the angle of incidence of the ray on surface 420 after reflecting off reflector 230 (θₗ) is greater than the critical angle for total internal reflection θc. Using geometric optics the following relationships can be derived:
θₗ=2φ−arc sin(sin(θᵢ)/n) (8)
θ_{c}=arc sin(1/n) (9)

The condition for determining the acceptance angle is:
θₗ=θ_{c} (10)

Substituting equations 8 and 9 into equation 10 we get:
arc sin(1/n)=2φ−arc sin(sin(θₐ)/n) (11)
θₐ=arc sin [n sin(2φ−arc sin(1/n))] (12)
φ=[arc sin(sin(θₐ)/n)+arc sin(1/n)]/2 (13)

from trigonometry it can be seen that:
CF=1/sin(φ) (14)

These equations can be interpreted physically in the following way. The TPC is a concentrator with asymmetric acceptance angle. This asymmetry has been a primary reason for this concentrator to be rejected by earlier researchers.

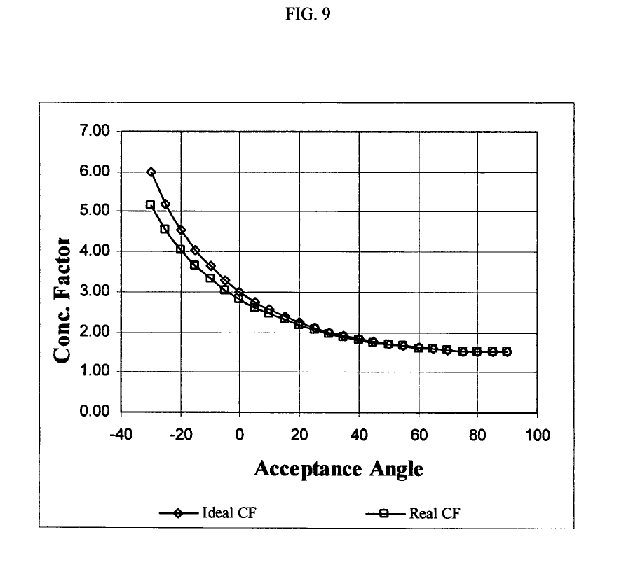

To compare this to an ideal asymmetric concentrator we can rewrite equation 6 for the asymmetric case.
CF=2n/(sin(θₗ)+sin(θᵣ)) (15)

Where θₗ and θᵣ are the right and left side acceptance angles. FIG. 9 plots this ideal concentration versus the TPC CF for n=1.5 and θᵣ=90°. Note that an acceptance angle can be less than 0° in the asymmetric case—indicating that light must be coming from the other side to be accepted. This can have useful applications for non-equatorial orientations. For the range shown, the TPC is very nearly ideal.

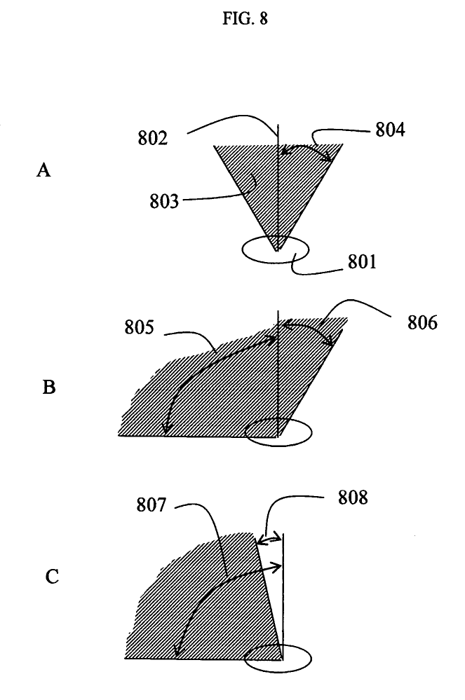

FIG. 8 shows a schematic view explaining the physical meaning of a negative acceptance angle. In FIG. 8A, light impinges on the aperture of a light concentrator 801 with an incident angle to surface normal 802. If the light comes from within the acceptance region 803, its incident angle is less than acceptance angle θₐ 804 and it is accepted, otherwise it will not be absorbed by the concentrator. FIG. 8B shows a light concentrator with asymmetric acceptance angles. Light coming from the left must be incident at an angle relative to the normal of less than θₗ 805, and light from the right must be incident at an angle relative to the normal of less than θᵣ 806 in order to be accepted. Finally, in FIG. 8C we see an asymmetric concentrator with a negative acceptance angle. All light coming from the right is rejected. To be accepted, light coming from the left must have an incident angle less than θₗ 807 but greater than the absolute value of θᵣ 808. Note than in all cases the acceptance angles are measured with respect to the surface normal.

Instead of a TPC of the type described above, embodiments of the present invention may use any asymmetric concentrator. By way of example, some embodiments of the present invention may use a parallel aperture prismatic light concentrator as described by Lichy in provisional patent 60/864,920, “Parallel Aperture Prismatic Light Concentrator” filed Nov. 8, 2006. FIG. 6 is a drawing of a prismatic light concentrator 600. It is comprised of a clear, flat entrance aperture 610, a primary flat reflector 620 disposed at an angle to flat entrance aperture 610, a secondary curved reflector 640 opposite primary flat reflector 620 and a flat exit aperture 630 parallel to the entrance aperture 610 and defined by the proximal endpoints of flat reflector 620 and curved reflector 640. The body of parallel aperture prismatic light concentrator 600 is comprised of a clear refractive material 650 having a refractive index greater than 1.

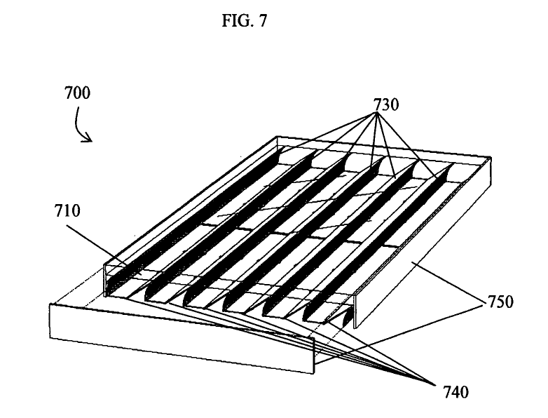

FIG. 7 shows an embodiment of the present invention where a plurality of parallel aperture prism concentrators are arrayed in a module with photovoltaic cells 740 optically coupled to the exit aperture of each individual concentrator 730. The entire module is enclosed by frame 750 and protected by front glass 710.

Optimization of an Asymmetric Concentrator

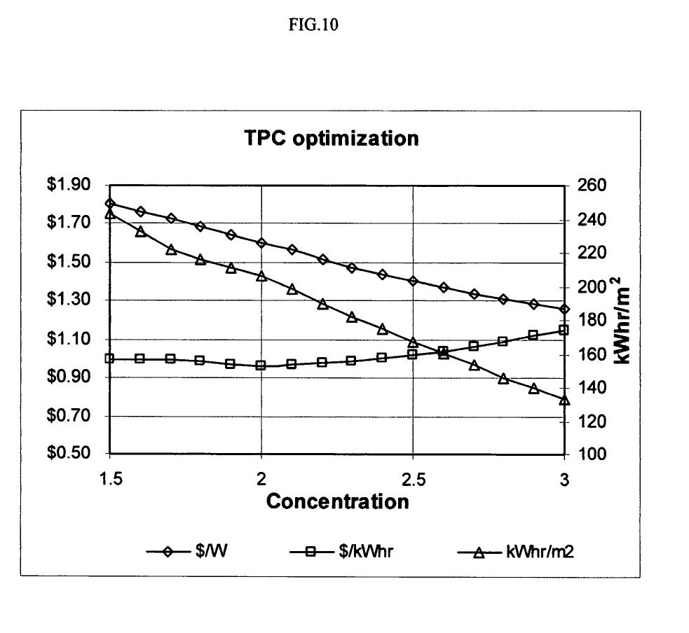

It has already been shown that asymmetric concentrators of the present invention may be oriented non-equatorially. Preferred embodiments of the present invention also include modules where the concentrator has been specifically optimized for non-equatorial orientation. In the following paragraphs, FIGS. 10, 11, and 12 are used to explain how one embodiment of the present invention (a TPC) can be optimized for particular applications, including the non-equatorial orientation of the present invention.

FIG. 9 plots the useful range of the TPC. For cases of negative acceptance angle (i.e. Light with normal incidence is rejected), the meaning of concentration factor becomes somewhat obscure. The value given is the geometric concentration, the ratio between the aperture and the target areas, however since the panel can not be oriented towards the sun the maximum flux achieved at the target is 1 sun times the CF times the cosine of the acceptance angle. A module with a negative acceptance angle will not function well in traditional orientations with the surface normal facing the path of the sun. In the case of the present invention, where module orientation is constrained to be outside the ecliptic, the geometric concentration factor is realized in that the module generates as much power as an unconcentrated module with CF times as much cell area in the same orientation.

First let us optimize the concentrator for the common case. We will define this as a stationary module oriented facing south with its normal parallel to the equatorial plane. We can then define three quantitative figures of merit. Cost per peak watt ($/W) is the traditional metric, but we should also include total annual energy output ($/kWhr)—which is especially important when considering the loss of diffuse light. We have already discussed the importance of area efficiency—this can be measured as annual energy per unit area (kWhr/m²). To derive absolute values for incident power we have assumed the module is located in San Jose, Calif. with 1.8 MWhr/m² annual incident solar energy, 20% of that diffuse. We are assuming a module comprised of 432 12.5 mm×125 mm cells, and have developed a cost model based on known molding costs, standard cell stringing and lamination costs. The optimized figures of merit are plotted in FIG. 10.

The most striking fact derived from FIG. 10 is how flat the $/kWhr curve is, even beginning to climb beyond CF=2.3. This is due to the constraint of a stationary module—beyond 2× concentration a module oriented as described will not capture all direct light. The same effect, coupled with the increasing loss of diffuse light leads to the downward trend of the kWhr/m² curve. Overall we can see that a concentration of about 1.9 yields close to optimal cost for energy without sacrificing much area efficiency (10%).

In real world applications it is often desirable to mount panels at the same pitch as the roof, rather than at the optimal tilt. Also, the concentrator is asymmetric, and the intent is to orient it with acceptance to the southern horizon.

The Non-Equatorial Facing Roof

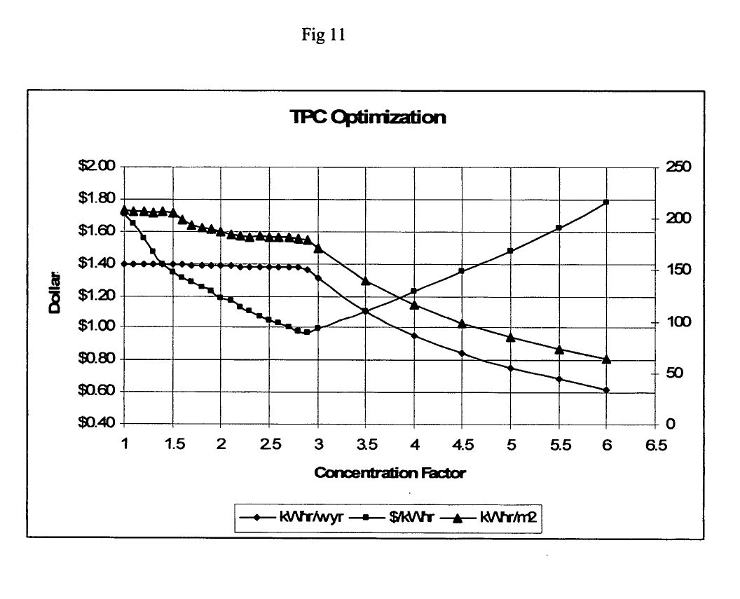

Having developed a tool for optimizing the concentrator based on orientation, it is now possible to carry out that optimization for non-equatorial cases. One common case is that of a flat roof. Many commercial buildings have roofs that are substantially horizontal. Current PV installations on these roofs either employ special means to tilt the modules more equatorially, or lay the modules flat on the roof at great expense. If the modules are tilted, space must be left between them to avoid shadowing, thus reducing area efficiency. Also, there are additional installation costs associated with the structure necessary to tilt the module. In the prior art only modules that did not employ concentrators could be laid flat as this is a non-equatorial orientation (outside of the tropics) and light would be rejected. For this reason, laying modules flat was not an economical solution. The present invention employs a concentrator in this non-equatorial orientation. FIG. 11 plots the optimization curve for a TPC in a flat orientation in San Jose, Calif. In this case a concentration factor of nearly 3 is optimal. A CF of 3 corresponds to an acceptance angle near 0 degrees (slightly negative).

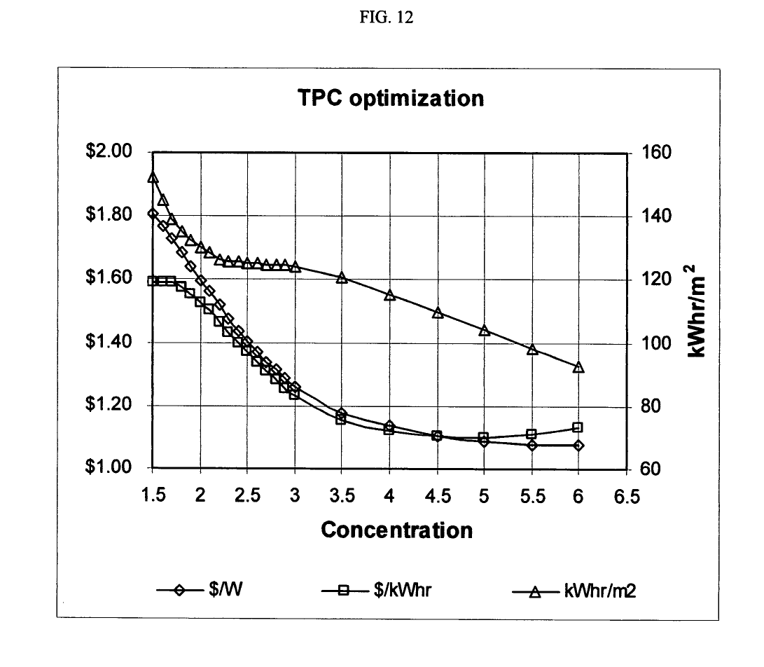

In the current state of the art, PV modules are generally not installed on north facing roofs. There are cases where it might be useful to do so. In California, for example, where most of the population lives below 38° N latitude and typical roof pitches are 15°-20°, north facing roofs receive 1.14 MWhrs/m². We have already seen that roof area is at a premium for these homes. FIG. 12 shows module performance versus CF for this case. The CF axis has been extended beyond the limit of 3 stated in section 3.2. The concentrator can still be stationary and equation 6 is not violated because of the asymmetry of the TPC. Recall that light with normal incidence will be largely rejected by this module, as described herein. The graph (FIG. 12) shows that the concentrator can be optimized around 4.5× with energy costs ($/kWhr) comparable to the lower concentration module on the south facing roof. Area efficiency is of course much lower for this condition—but it enables use of area that is otherwise not useable for PV.

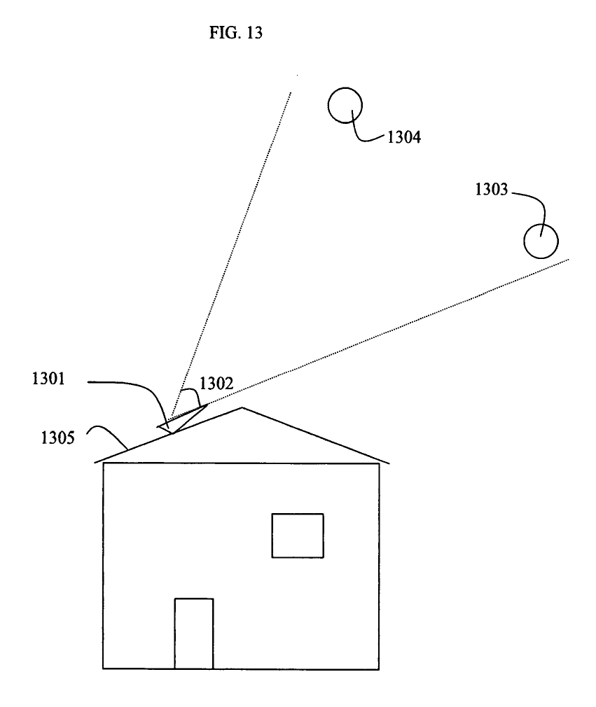

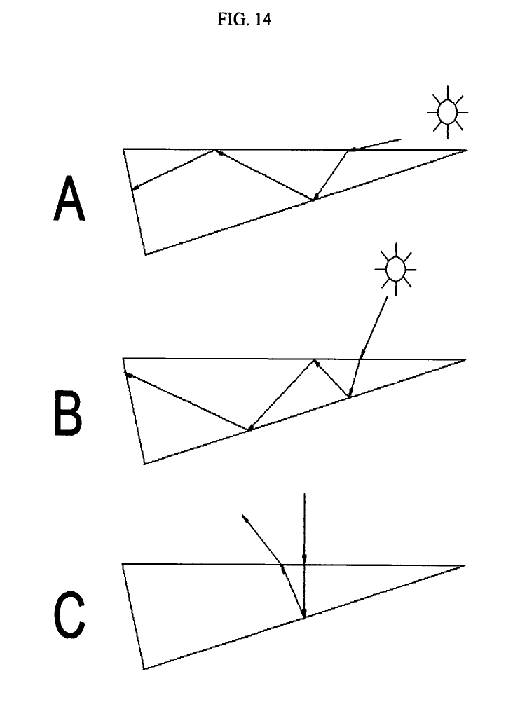

FIG. 13 is a schematic representation of a PV module optimized for use on north-facing roofs installed on such a roof. The drawing shows a building viewed from the west with a 3/12 pitched roof. Asymmetric concentrator PV module 1301 is mounted on north-facing roof 1305 such that acceptance angle 1302 covers a portion of the southern sky that extends from below the minimum solar elevation at winter solstice 1303 to above the maximum solar elevation at summer solstice 1304.

FIG. 14 shows ray traces of a TPC optimized for use on a non-equatorial facing surface. In FIGS. 14A and 14B sunlight from the south is collected and received by the PV cell. FIG. 13C shows light at normal incidence being rejected, and reflected out of the concentrator.

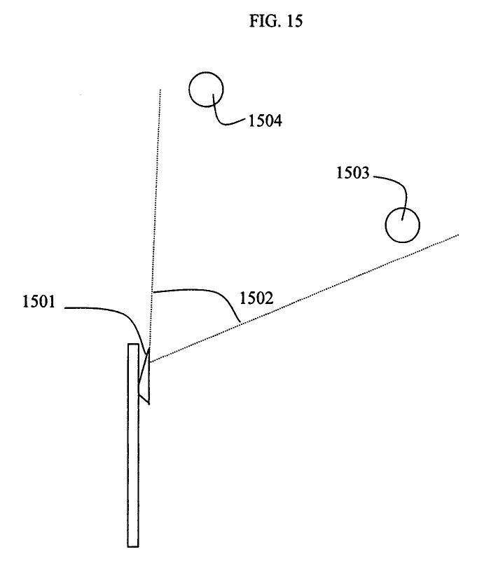

FIG. 15 shows another embodiment of the present invention. Specifically in the case where a module is oriented with its normal below the minimum solar elevation at winter solstice, that is with the normal pointing south in the northern hemisphere, or north in the southern hemisphere. In this case, the module is oriented vertically on a wall.

It is understood that the embodiments described within this application are two dimensional concentrators that concentrate light in a generally north-south direction. It is envisioned that asymmetric three dimensional concentrators that concentrate light in the east-west direction as well as the north-south direction, whether concentration in the east-west direction is symmetric or not, may be employed to achieve higher concentration factors than what may be achieved with a two dimensional concentrator. For instance, simple, known modifications to the TPC or Parallel Aperture Prism Concentrator can increase their concentration factors by a multiple of 1.5 without significant loss of collection time by concentrating light in the east-west direction.

It is understood that the forms of the invention shown and described in the detailed description and the drawings are to be taken merely as examples. It is intended that the following claims be interpreted broadly to embrace all the variations of the example embodiments disclosed herein. Thus the scope of the invention should be determined by the appended claims and their legal equivalents, rather than by the examples given.

What is claimed is:

1. A method for generating electrical energy from non-equatorial facing surfaces, comprising the steps of:
identifying a non-equatorial facing surface; and
installing a photovoltaic module with a light concentrator on the non-equatorial facing surface.

2. The method for generating electrical energy of claim 1 wherein the light concentrator has an asymmetric acceptance angle.

3. The method for generating electrical energy of claim 2 wherein the light concentrator with asymmetric acceptance angle has a negative acceptance angle on one side of the surface normal, and most light entering the concentrator normal to the surface is rejected.

4. The method for generating electrical energy of claim 2 wherein the light concentrator is a triangular prism concentrator array.

5. The method for generating electrical energy of claim 2 wherein the light concentrator is a two dimensional concentrator, concentrating light in a predominantly north-south direction.

6. The method for generating electrical energy of claim 2 wherein the light concentrator is a two dimensional concentrator, concentrating light in both north-south and east-west directions.

7. The method for generating electrical energy of claim 3 wherein the light concentrator is a triangular prism concentrator array.

8. The method for generating electrical energy of claim 3 wherein the light concentrator is a two dimensional concentrator, concentrating light in a predominantly north-south direction.

9. The method for generating electrical energy of claim 3 wherein the light concentrator is a three dimensional concentrator, concentrating light in both north-south and east-west directions.

10. A radiant energy concentrator, comprising:
a light concentrator;
a photovoltaic element, the photovoltaic element being optically coupled to the light concentrator, whereby the radiant energy concentrator is adapted to be placed on a non-equatorial facing surface.

11. The radiant energy concentrator of claim 10 wherein the light concentrator has an asymmetric acceptance angle.

12. The radiant energy concentrator of claim 10 wherein the light concentrator is a two dimensional concentrator, concentrating light in a predominantly north-south direction.

13. The radiant energy concentrator of claim 10 wherein the light concentrator is a three dimensional concentrator, concentrating light in both north-south and east-west directions.

14. The radiant energy concentrator of claim 10 wherein the light concentrator is a triangular prism concentrator array.

15. The radiant energy concentrator of claim 10 wherein the light concentrator has a concentration factor between 1.8 and 7.5.

16. The radiant energy concentrator of claim 10 wherein most light at the normal axis perpendicular to the primary plane of the radiant energy concentrator is rejected.

17. The radiant energy concentrator of claim 16 wherein most light at some angle other than the normal axis is accepted.

18. The radiant energy concentrator of claim 10 wherein at least 90% of the light at the normal axis perpendicular to the primary plane of the radiant energy concentrator is rejected and at least 90% of the light at another angle is accepted.
